(19) United States
(12) Patent Application Publication
(10) Pub. No.: US 2021/0229580 A1
(43) Pub. Date: Jul. 29, 2021

(54) 3 in 1 Truck

(71) Applicant: Sonya D. Waters-Banks, Garland, TX (US)

(72) Inventor: Sonya D. Waters-Banks, Garland, TX (US)

(73) Assignee: Sonya D. Waters-Banks, Garland, TX (US)

(21) Appl. No.: 17/026,107

(22) Filed: Sep. 18, 2020

Related U.S. Application Data
(60) Provisional application No. 62/948,154, filed on Dec. 13, 2019.

(51) Int. Cl. B60N 2/30; B62D 25/20; B60J 5/10; B60J 7/00; B60N 2/005; B60N 2/02

(52) U.S. Cl. CPC B60N 2/30; B62D 25/20; B60N 2/0224; B60J 7/00; B60N 2/005; B60J 5/10

(57) ABSTRACT

An addition to truck beds with a subsequent amount of seating for additional passengers. The seating is manufactured from waterproof material to eliminate deterioration from outside elements. The seating is embedded under grip proof covering which retracts and extracts from the truck floor bed by a push button module located on the driver side panel near the headlight switch. Retraction and extraction of the grip proof cover is motor operated and folds into a W shape against the bed head. The seating will expand upward and downward by manual power. The additional seats will be one or two row seat options per consumer choice. The row seats will come equipped with seat belts and headrest for stabilization to the passenger. The row seats are bolted down to the bed of the truck and are non-removable. The retractable flooring will lock back into place by metal hinges.

### BRIEF DESCRIPTION OF EACH DRAWING

FIG. 1 is a cut away view of the 1. foldable row seats positioned horizontally and folded upward that will have a 2. small button on the front of the seats to elevate and escalate for height, this view also shows the 3. cover open that is connected to an 4. electronic pulley that delegates the opening by sliding open moving underneath the row of foldable seat in the rear of the bed that is protected from weather by the 5. outer layer of the truck/SUV outer cover 8. Is showing the controls on the side of the chair that helps the seats fold.

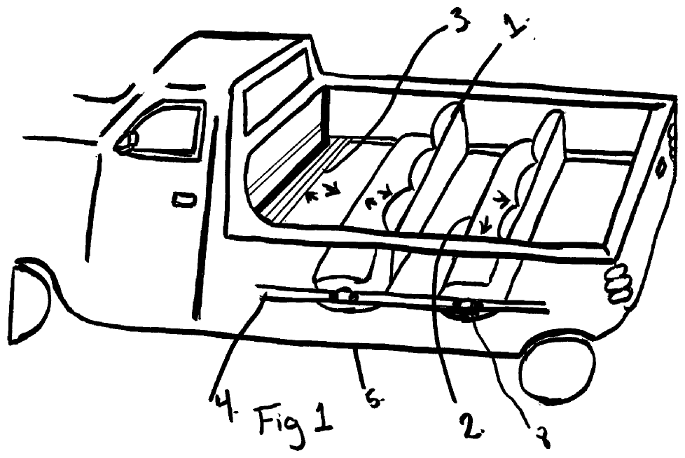

FIG. 2A is a diagonal view of the 6. row seats positioned vertically and folded upward.

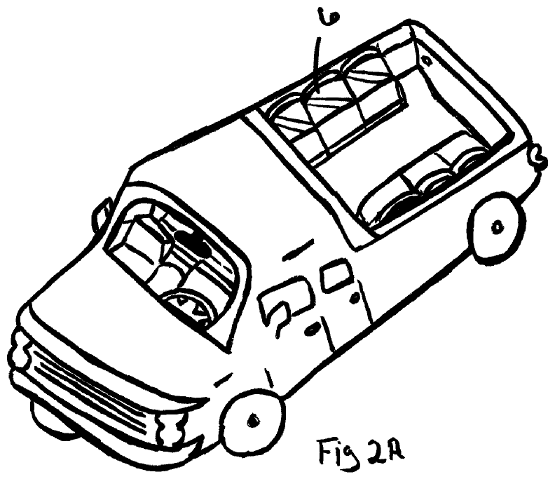

FIG. 2B is a view of the 7. row seats positioned vertically and folded down, displaying the back door that opens to the side.

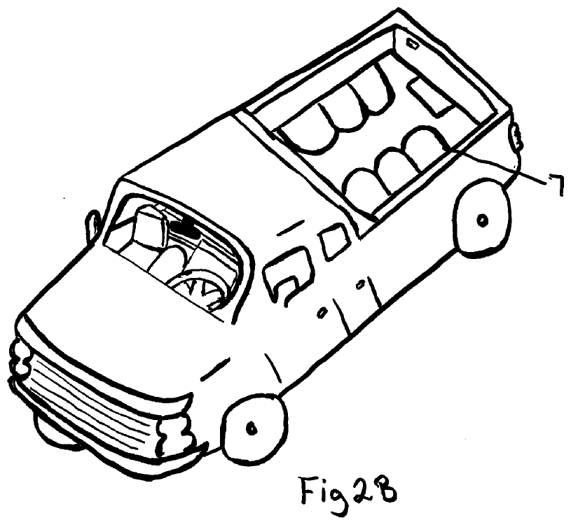

FIG. 2C is a view of the 9. row seats positioned horizontally and folded down.

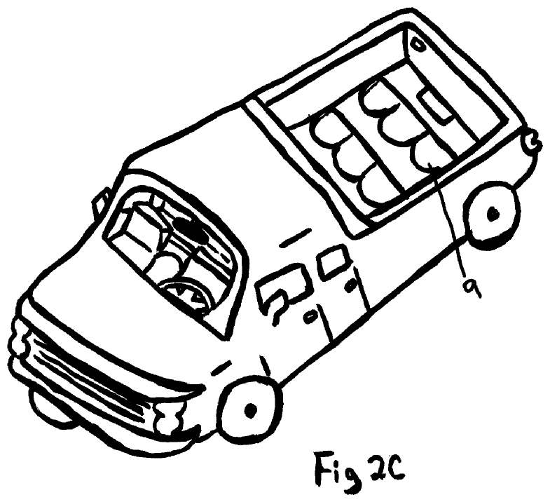

FIG. 3A is a view of the truck bed with the 3. floor cover closed, the seat will be fold so as the cover slides over the seat they will sink down lower to give the cover room to close completely and lock.

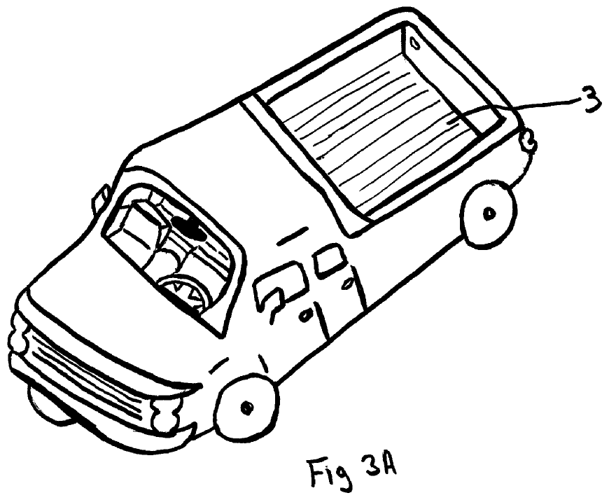

FIG. 3B is a view of the truck bed with the 3. floor cover retracting, with 7. the seats showing folded.

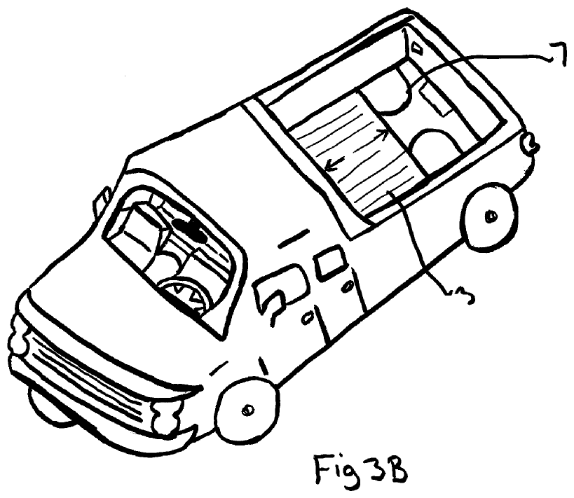

FIG. 3C is a view of the truck bed with the floor 3. cover showing retraction and showing the 10. rear window ½ down.

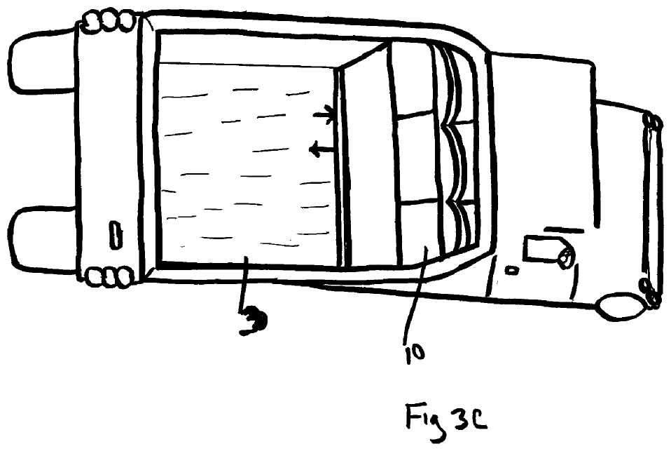

FIG. 4A is a top view displaying the 11. detachable truck bed door open with the truck bed 3. cover detracted.

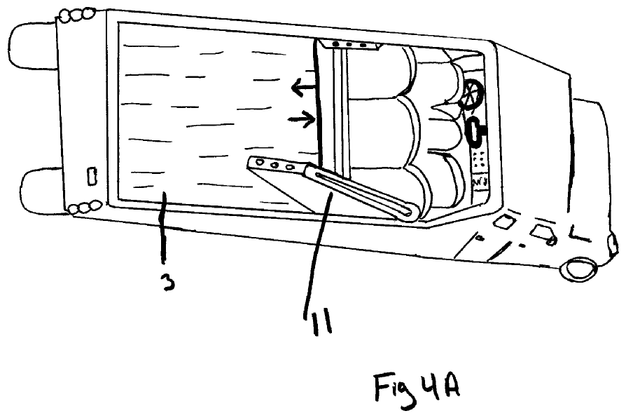

FIG. 4B is a top view displaying the 11. detachable truck bed door open with the truck bed cover retracted with the 7. foldable seats down and the 10. rear door window ½ open.

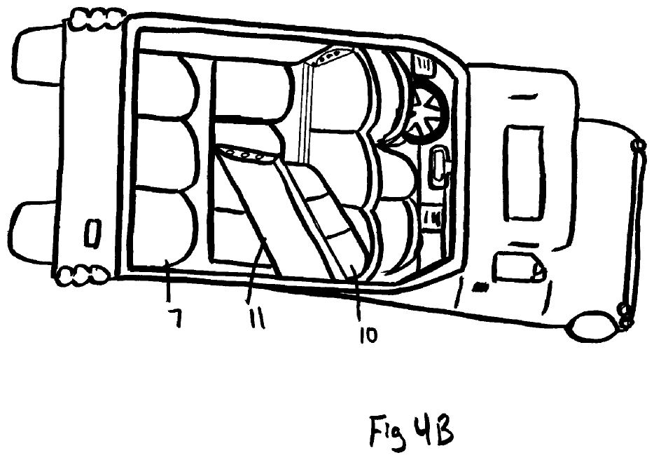

FIG. 4C is a top view displaying the 11. detachable door open/completely removed, with the 1. foldable seats open.

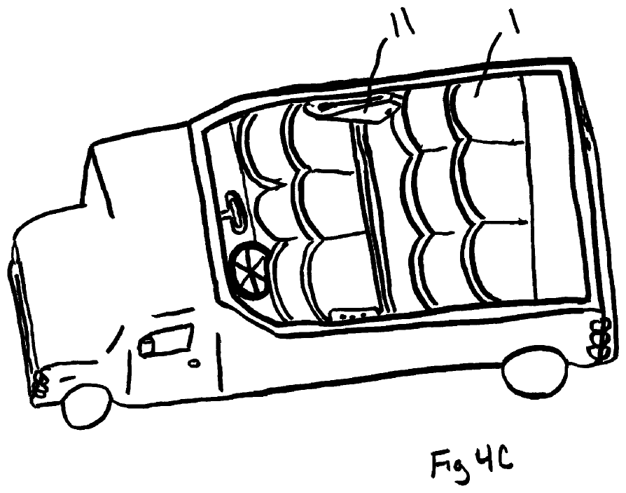

FIG. 5A is a top view displaying the 12. soft top cover rising from the rear truck bed gate.

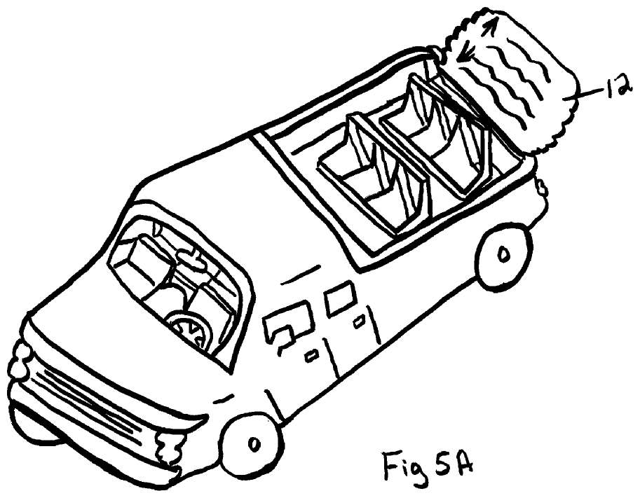

FIG. 5B is a view displaying the 12. soft top cover partially positioning itself to cover the truck bed covering seats and going into SUV/truck style.

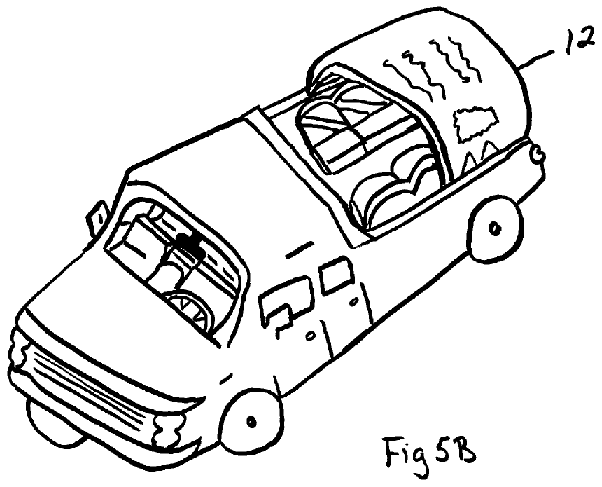

FIG. 6 is a view displaying the soft top cover retracted and stored in the 13. rear truck bed gate.

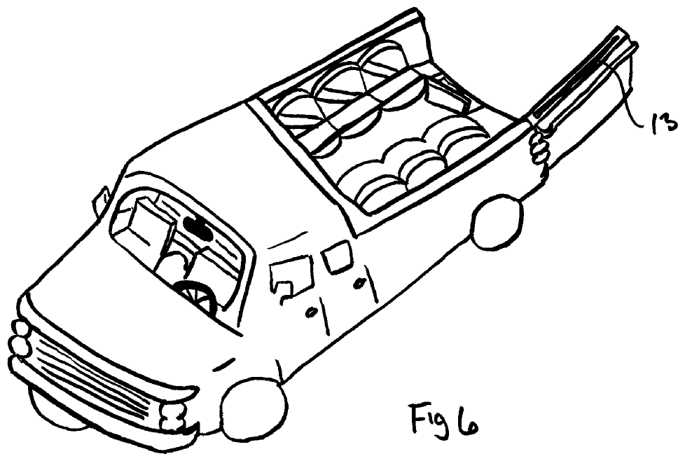

FIG. 7 is a view displaying the 12. soft top cover over the entire truck bed.

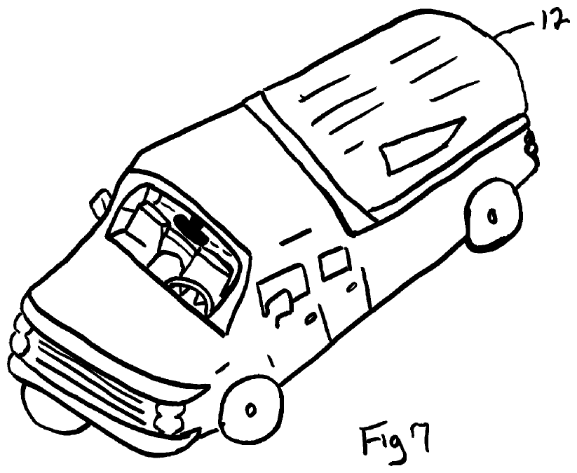

FIG. 8 is a view displaying the 14. hard top cover over the entire truck bed.

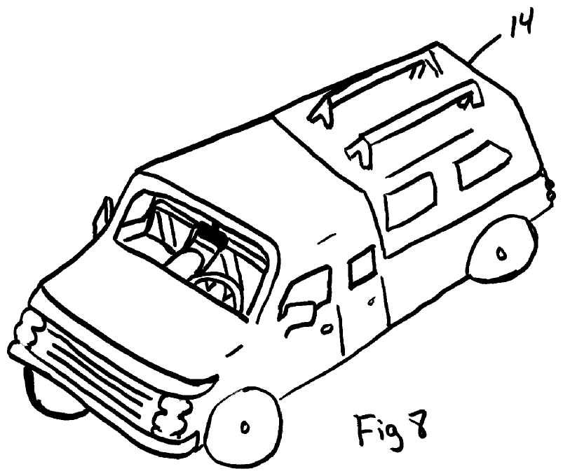

FIG. 9 is a view displaying the 16. driverside control module for the window in the 15. detachable truck bed door.

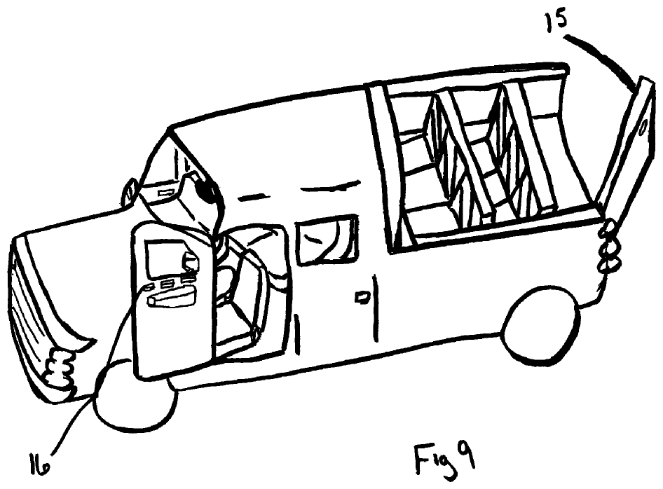

FIG. 10 is a top view displaying the overall functions: 3. retractable floor cover, 1. foldable truck bed seats, 11. detachable truck bed door, 12. soft top cover inside the 13. rear truck bed gate and the 16. control modules for the window of the rear truck bed door is located only on the driver side.

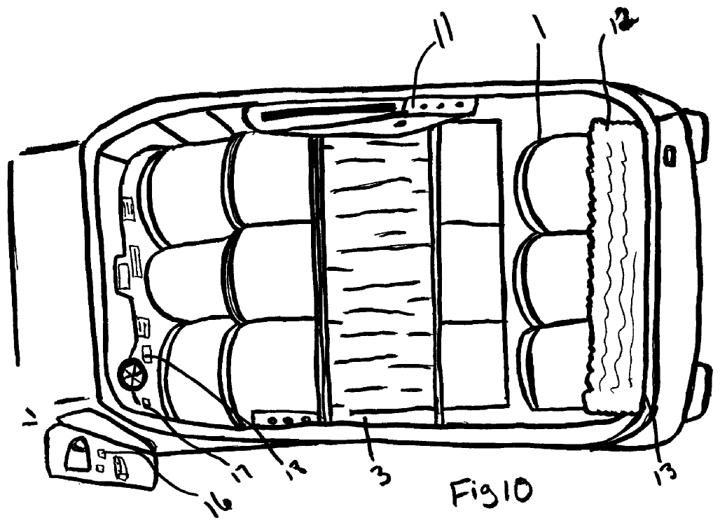

FIG. 11 is a view displaying the control modules for the 17. soft top cover and 18. row seats in the truck bed located under the driver wheel.

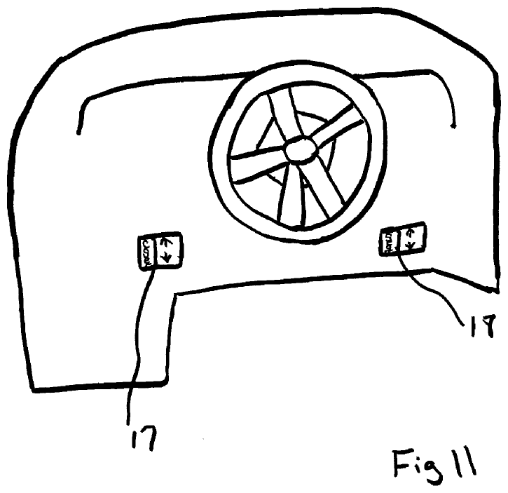

### THE 3 in 1 TRUCK/SUV SPECIFICATION

This is an explanation of the 3 in 1 truck/SUV design. The concept of this design is based on transforming a truck into a SUV for the working class consumer that acquire all additional sitting individual & family/group use. The additional room is located in the rear of the truck bed with a thin sturdy metal cover hiding the additional foldable seats with built in seatbelts. The additional seating will be a hidden folding row seat embedded in the truck bed. The seating will be located in 2 different positions; one position will be the seats placed against the truck bed walls vertically; the other position will be the seats placed horizontal in the truck bed. These 2 positions will give the consumer's a choice of how they want the additional seating placed in the truck bed (refer to drawings). The seating will allow an additional 2-6 passenger's. The seating will be water-proof material as the bed will not always be covered based on the drivers need for the vehicle. The hidden sectional bed will contain water leak holes to release any water that is harbored in the hidden sectional bed area in the case of environment change. The bed of the truck will come with a hard top or soft top cover based on the consumer's preference. The top will be removable as well, and the soft top is located in the rear tail gate of the truck. This will also cover the bed of the truck & the hidden seats there will be a control button/module inside the truck on the driver's left side next to the head light switch. The control button/module will allow the metal bed cover to fold and slide underneath the truck allowing the folded seats to appear. The seats will be able to fold and unfold and will have a button on the side that will elevate the seats in the bed of the truck after the bed cover is no longer in position. The There will be a ventilation system in the rear of the truck for ac/heat to flow through when the truck bed is covered. On the rear of the truck there is a door handle on the right side to open the door. This is a manually door that's accessible from the inside out with automatic window accessible for driver side only. This will make it easier when it's time to transform the truck into the SUV style & this is a wonderful ride for summer & spring when you take off the top for friends/rider's to enjoy the perfect weather together or spaced apart. The 3 in 1 Truck is a truck, a drop top for the rides in the back, and a SUV!

We claim:

1. A pickup truck/SUV bed comprising of foldable row seating.

2. A pickup truck bed/SUV comprising of an electric retractable floor covering for row seats.

3. A pickup truck bed/SUV comprising of a detachable door between the truck bed and truck cabin.

4. A control button module to the window on the detachable truck bed door with control module being located only on the driver's side.

5. A control button module for the seats in the truck bed with the control module located under the steering wheel.

6. An arrangement for attaching a soft top cover over the truck bed.

7. An arrangement for attaching a hard top cover over the truck bed.
